(19) United States
(12) Patent Application Publication
(10) Pub. No.: US 2013/0179944 A1
(43) Pub. Date: Jul. 11, 2013

(54) Personal area network (PAN) ID-authenticating systems, apparatus, method

(71) Applicants: Douglas Everett Kozlay, Timonium, MD (US); Alan D. Kozlay, Belcamp, MD (US)

(72) Inventors: Douglas Everett Kozlay, Timonium, MD (US); Alan D. Kozlay, Belcamp, MD (US)

(21) Appl. No.: 13/374,732

(22) Filed: Jan. 11, 2012

(51) Int. Cl. H04L 9/00; H04L 29/06

(52) U.S. Cl. 726/4; 726/7

(57) ABSTRACT

This invention comprises a system, apparatus, and method ensuring device adherence to security requirements for Personal Area Networks (PANs). Provided security services protect data communicated between PAN-hub-attached devices and their resident data. The invention provides cryptographic keys and certificates, to protect communications between PAN-hub-attached devices, and optional external devices. The invention provides cryptographic software complying with established security requirements for PAN networks. Users submit credentials using: (1) ID smartcards inserted into the PAN hub security apparatus, (2) a cellphone/SIM card, and/or (3) a PIN or password. Based on privileges, users securely access the PAN hub and authorized devices. The PAN hub apparatus ensures that communications between PAN network devices, external devices, and data-at-rest are cryptographically protected, complying with network security requirements. Optionally, the invention permits users and/or PAN network device(s) to obtain connectivity to external “non-PAN” devices. The method specifies cryptographically-secured communications between PAN network devices and external devices. This invention comprises a system, apparatus, and method ensuring device adherence to security requirements for Personal Area Networks (PANs). Provided security services protect data communicated between PAN-hub-attached devices and their resident data. The invention provides cryptographic keys and certificates, to protect communications between PAN-hub-attached devices, and optional external devices. The invention provides cryptographic software complying with established security requirements for PAN networks. Users submit credentials using: (1) ID smartcards inserted into the PAN hub security apparatus, (2) a cellphone/SIM card, and/or (3) a PIN or password. Based on privileges, users securely access the PAN hub and authorized devices. The PAN hub apparatus ensures that communications between PAN network devices, external devices, and data-at-rest are cryptographically protected, complying with network security requirements. Optionally, the invention permits users and/or PAN network device(s) to obtain connectivity to external “non-PAN” devices. The method specifies cryptographically-secured communications between PAN network devices and external devices.

### BACKGROUND OF THE INVENTION

1. Field of the Invention

The field of the invention is providing security services ensuring device compliance with minimum network security requirements. The invention field is also providing secure cryptographic credentials to protect data communicated between PAN-hub-attached devices and/or to protect data residing in said devices. Also disclosed is providing cryptographic keys and certificates for protecting communications between at least two PAN-hub-attached devices on a PAN network (and devices external thereto) and for protecting data-at-rest in memory. The field of the invention also ensures wireless PAN-network devices comply with established minimum network security requirements. Requirements typically include enforcing device adherence to: cryptographic algorithm standards and implementation, cryptographic key length (longer keys increase cryptographic key strength), certificate type and source, and equipment approval from certifying agencies, (etc., as required by a network operator). The field of the invention also (optionally) ensures users are authenticated prior to use of their PAN hub security apparatus and PAN-attached networked devices, using an ID smartcard, biometrics, password, and/or PIN. Authentication can also be done by devices containing SIM cards (e.g., a cellphone/SIM). My inventions further ensure that authorized, authenticated users are allowed—via their PAN hub security apparatus—to access PAN-networked devices, and by extension, to access any assigned PAN-networked peripherals.

2. Related or Comparable Inventions

There are diverse inventions serving needs of Personal Area Network (PAN) users. There are other products for improving network security. Despite these contributions to the art, there is no product directly comparable to the present invention. The invention allows only authorized PAN users to access devices attached to their PAN, or to other networks they are allowed and privileged to access, where network security is a concern.

3. Necessity of the Invention

There is a long history of computer network security products and services provided in hardware and software. One recent trend is to connect, often wirelessly, multiple pieces of electronic equipment—devices that are carried or worn by a user—which can make it accessible to other devices and/or networks (e.g., the Internet). Such interconnections for inter-exchanging data are termed or called Personal Area networks, or PANs. PAN device products are vastly increasing in number and becoming more economical and easier to implement; Notwithstanding, many basic, fundamental network security issues remain unresolved. To my knowledge, there are no comparable PAN security products on the market comparable to the present invention. It appears that the present invention will satisfy security-oriented PAN users and organizations that protect their networks.

### SUMMARY OF THE INVENTION

### The Apparatus of the Invention

The apparatus comprises a wireless PAN hub security device to implement a secured Personal Area Network (PAN). The apparatus provides security services to protect data communicated between PAN-hub-attached devices and/or data residing in the devices.

The apparatus provides cryptographic keys and certificates protecting communications between two or more PAN-hub-attached devices on a PAN network (and optionally devices and/or networks external to a user's own PAN). Optionally, where implemented, the apparatus is adapted for ID smartcard cardholding, card reading and interpretation of user privileges. An ID smartcard version is worn, carried, or “snapped on” for viewing, after a user authenticates to a PAN hub security apparatus. Typically, an ID smartcard or card is assigned to each user. After card insertion, a PAN hub security apparatus reads data indicia embedded in and/or on a card, interprets user access privileges, security level, and other authentication (if any) required to use one or more network devices (and/or other PAN hubs, PAN-networks, or other external networks or devices). A PAN hub optionally supplies cryptographic services for encrypting and authenticating messages and data-at-rest (i.e., saved data in the device memory).

### The System of the Invention

The system comprises an integrated PAN hub security system to implement one or more secured Personal Area Networks (PAN). Individual apparatuses of the system provide security services to protect data communicated between PANs, their PAN-hub-attached devices and/or data residing in devices. In the overall system, one or more PAN hub security apparatuses provide multiple sets of cryptographic keys and certificates protecting communications between two or more PAN-hub-attached devices on a PAN network, or external thereto. The system can be deployed organization-wide, affecting multiple PANs, interfacing non-PAN devices, and interfacing non-PAN networks, ensuring uniform user and device adherence to and compliance with minimum security requirements. Optionally, and beyond protecting devices, the system can be deployed allowing the apparatus to accept user authentication credentials presented by an ID smartcard, and/or by a SIM card (for example using a cellphone or smartphone), or also optionally, user authentication credentials can be presented using a simple PIN or password. The system can be implemented to allow for multiple users—e.g., each user is assigned one or more PAN hub security apparatuses with a PAN-ID cardholder—plus an optional ID card—to securely access both authorized PAN-attached peripherals and authorized external resources. “Unsecured” (i.e., no ID card or password required) versions can also be provisioned, where only device security is an issue.

### The Method of the Invention

The method of the invention (via its system and apparatus) provides instructions, steps, and techniques for protecting data communicated between PAN-hub-attached devices and/or data residing in the devices. The method for using the apparatus, is to provide cryptographic keys and certificates protecting communications between two or more PAN-hub-attached devices on a PAN network (and optionally devices and/or networks external to a user's own PAN). Methods include providing PAN hub network security operating rules, procedures, security standards and minimum interface requirements (which must be met or exceeded) by devices attached to a PAN network.

In some versions of the invention where separate user authentication credentials are managed by an ID smartcard, users must be authorized to obtain an ID smartcard, card, PIN, and/or to use biometric inputs to self-authenticate, in order to access the PAN hub security apparatus, prior to making any access to protected PAN network devices.

Typically, PAN network users are issued a PAN hub security device with one or more wirelessly- or directly-connected “PAN network-attached” devices. In some versions of the invention, optionally, user authentication credentials and associated privileges are indicated in a smartcard by a set of randomly-generated cryptographic keys/certificates for each user, where implemented. If (prior to connection to a PAN network) a PAN hub security apparatus detects that a prospective PAN device fails to meet or exceed minimum security standards or requirements, the PAN hub denies a network connection. Where applicable, each authorized PAN user (after inserting an ID card or another security input) gains access only to PAN-network-attached devices permitted the user. If, e.g., a PAN hub has 4 devices attached and a prospective user only has privileges for 3 of the 4 devices, the user's access to that 4^{TH} device is denied. If access is granted, cryptographic keys on the smartcard encrypt and decrypt data on the card, within the memory of the PAN devices and on communications paths between PAN devices, or as applicable.

### FIGURES AND REFERENCE NUMERALS

### FIGURES

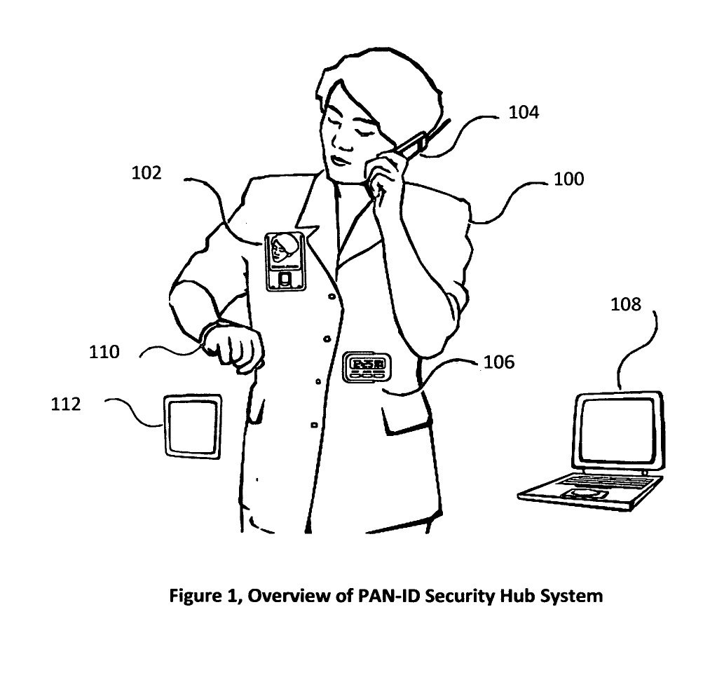

FIG. 1: Overview of the PAN Security System

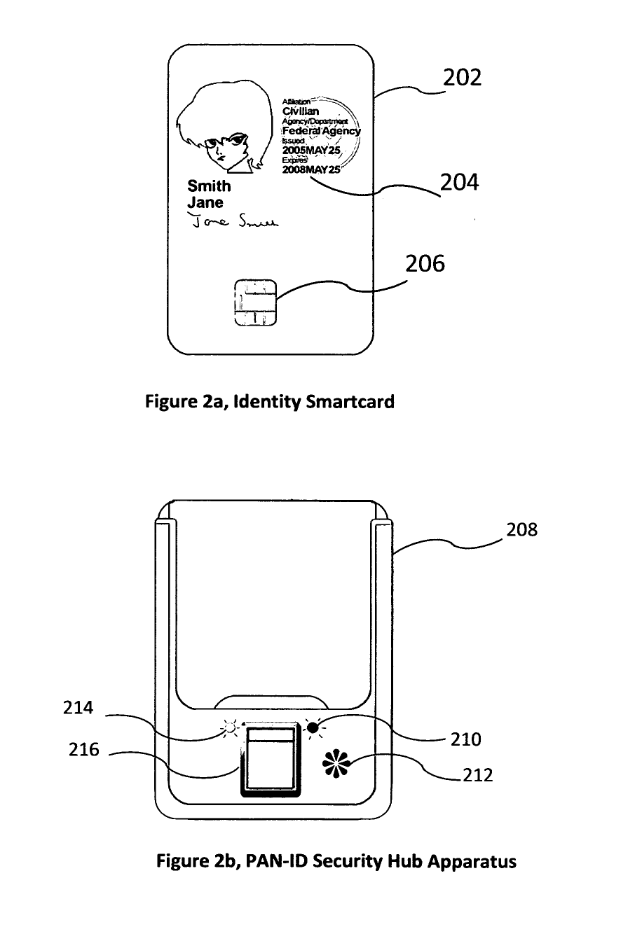

FIG. 2a: ID Smartcard or card

FIG. 2b: PAN-ID security hub and cardholding device

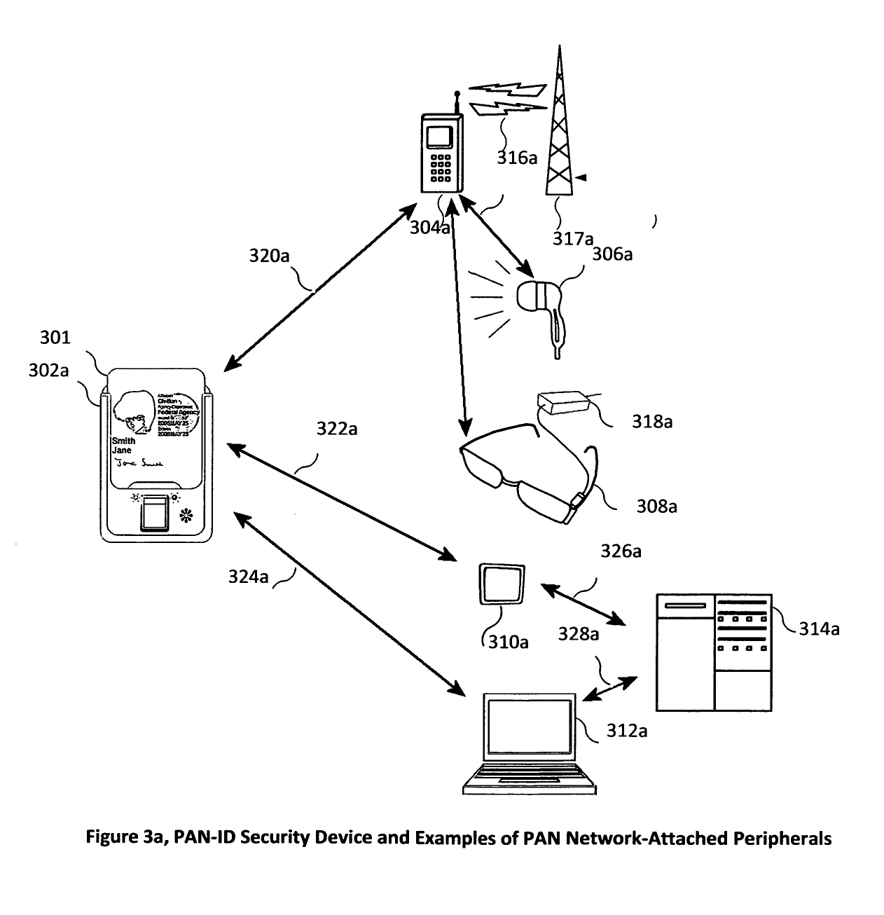

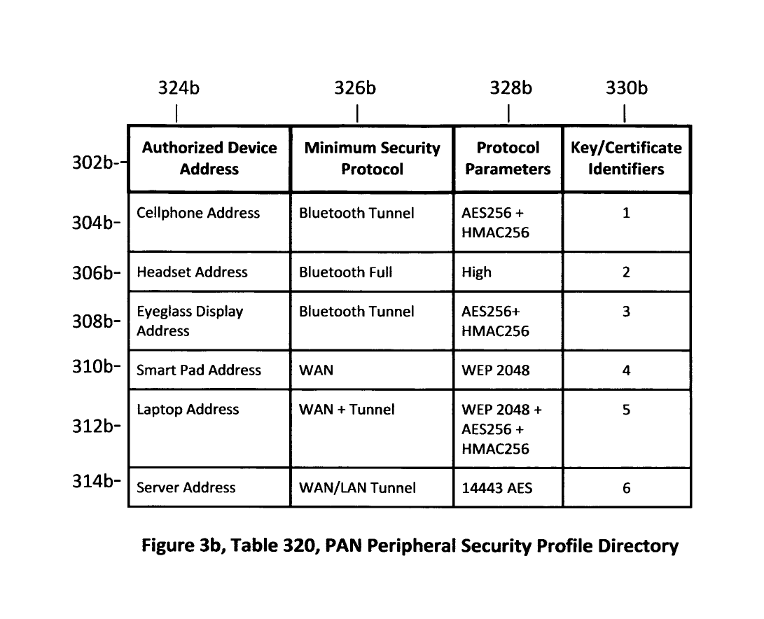

FIG. 3a: Components of the PAN Security System

FIG. 3b: Table of Security Data associated with each PAN Component

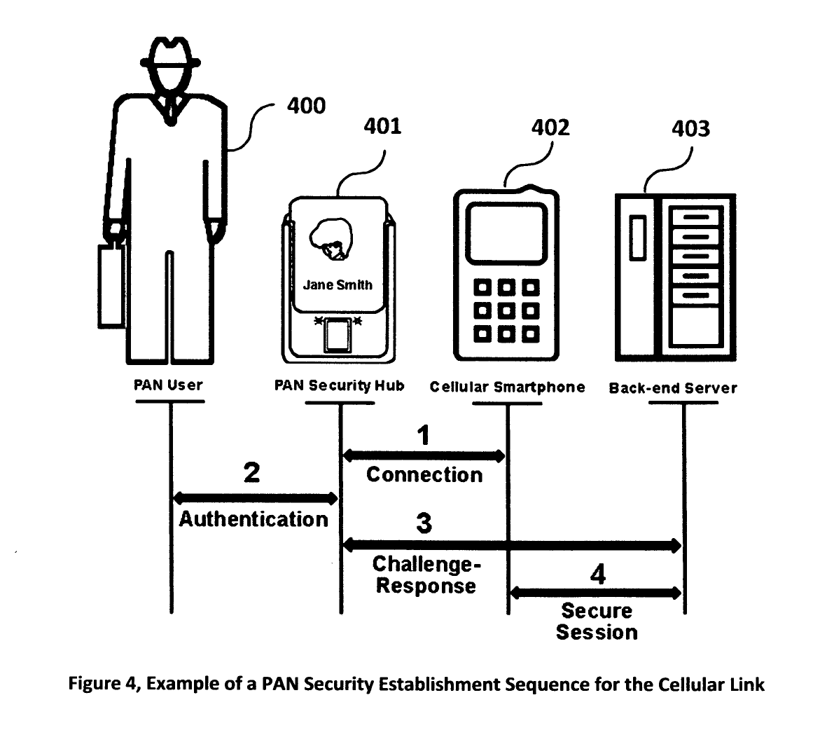

FIG. 4: Sequence of a Typical Cryptographic Protocol for a PAN Peripheral

### REFERENCE NUMERALS

FIG. 1: Overview of the PAN Security System

100 Employee outfitted with PAN-ID and PAN-attached peripheral devices

102 PAN-ID security hub cardholding apparatus with ID/smartcard

104 Cell Phone

106 Conventional Pager

108 Mobile laptop PC or workstation, connected to network

110 Wristwatch and display device

112 “PAD” portable computer for inventory control (or other use)

FIG. 2a: ID Smartcard or Card

202 Identity Smartcard, RFID card, and/or contact/contactless ID device

204 Printed indicia as required by the issuing organization/security administrators

206 Microprocessor

FIG. 2b: PAN-ID Security Hub and Cardholding Device

208 PAN-ID security hub cardholding apparatus with ID/smartcard

210 RED Light-emitting diode (LED) shows transaction and/or ID is NOT valid

212 Microphone and/or speaker (for sound cues, speech or voice corns)

214 GREEN LED shows transaction and/or ID is VALID and/or allowed

216 Biometric sensor (or swipe-sensor) for verifying user ID via fingerprint(s)

FIG. 3a: Components of the PAN Security System

301 Identity Smartcard, RFID card, and/or contact/contactless ID device

302a PAN-ID security hub cardholding apparatus with ID/smartcard

304a Cellular Telephone, Smartphone, PDA, and/or other communicating handset

306a Security-oriented Bluetooth Headset (extremely resistant to hacking)

308a Security-oriented communicating Eyeglasses (extremely resistant to hacking)

310a Security-oriented Tablet Computer connected to the PAN hub network

312a Security-oriented Desktop Computer connected to the PAN hub network

314a Security-oriented Mainframe Computer connected to the PAN hub network

316a Telecommunications signals input to and output from tower antennas

317a Communications Tower for receiving and transmitting selected signals

318a Security-oriented interface connects Eyeglasses 308a to the PAN hub network

FIG. 3b: Table of Security Data Associated with each PAN Component

302b Security Table: Device Address, Security Protocol, Parameters, Keys, Certificates

304b Cellphone Security Profile for this PAN peripheral

306b Headset Security Profile

308b Eyeglass Display Security Profile

310b Smart Pad Security Profile

312b Laptop Security Profile

314b Access Panel Security Profile

FIG. 4: Sequence of a Typical Cryptographic Protocol for a PAN Peripheral

400 User of the PAN devices

401 PAN Security HUB device

402 Cellular smartphone with security software

403 Back-end server for cellular phone text communications

FIG. 4 (cont'd.): Method—Steps 1, 2, 3, & 4: Security Protocol (High-Level Sequence)

Step 1: Connection: network connection to the cell phone

Step 2: Authentication: User credential input (PIN, fingerprint, other biometrics, etc.)

Step 3: Challenge-Response: Device authentication followed by key management

Step 4: Secure Session: Secure, encrypted, authenticated communications session

### DETAILED DESCRIPTION OF THE INVENTION

Referring now to FIG. 1, an overview of a PAN Security System and a PAN network is depicted. An employee 100 is shown wearing PAN-hub security cardholding apparatus 102 (the security hub device plus the employee's inserted ID/smartcard). Employee 100 is outfitted with a number of PAN-attached peripherals. This drawing indicates the wide variety of PAN-attachable devices which can communicate among each other and employee 100 (and also externally of 100's PAN (via apparatus 102) to other PANs (in accord with each PAN's access/interconnectivity privileges). The overview FIG. 1 depicts a Personal Area Network (PAN) including cellphone 104, a pager 106, laptop 108, communicating wristwatch 110 (with PAN network interfaces), and a “tablet” personal computer 112. These devices use a variety of communication protocols (further described in FIG. 4 below). These examples exhibit the diversity of device which can connect to employee 100's PAN network, in accord with security and access privileges as applicable.

FIG. 2a shows a closer view of the PAN-ID security hub/cardholding apparatus of the invention. The ID/Smartcard 202 is a typical smartcard with onboard memory and sufficient processing capability to provide security protection for the ID information embedded on the smartcard, and can optionally include cryptographic security services including encryption and digital signature calculation using keys that reside within the smartcard 202. The card only provides access to these security data when its files are unlocked by an access code presented by the PAN-ID security hub.

The card 202 is typically imprinted with the employee's name and a picture of the person, as well as other organization-specific printed information 204 required by the organization's security administrator, network operator, and/or network security manager. Typically a smartcard chip 206 is embedded in the plastic substrate card, in accordance with ISO Standard 7816 for contact smartcards. Here, chip 206 contains access controls, embedded software, and cryptographic data (later described herein).

FIG. 2b shows a detailed view of PAN-ID security hub/cardholding device 208. It is an attachable/wearable device adapted for insertion of the ID smartcard such as that shown in FIG. 2a. Device 208 is usually affixed (worn by clip, pin, or “snapped on”, not shown) onto an end-user's clothing surface where it's obvious for easy presentation, viewing, and inspection.

Typically, this device deploys like many other ID cards, on upper-front (chest) area of employee 100's jacket (as in FIG. 1). Additionally disposed on device 208 is an optional biometric fingerprint identification sensor 216. Sensor 216 is part of a hardware and embedded software-implemented fingerprint authentication subsystem. Sensor 216 is affixed onto device 208 so it is exposed for easy fingerprint authentication verification of the authorized user.

This sensor structure is well-known in the art as described in patents such as U.S. Pat. No. 7,480,637 to Kozlay. If a user's biometric fingerprint authentication is successful at identifying the authorized user's fingerprint, then LED 214 will light green and enable all of the security functions of device 208 that are described for this invention. Device 208 serves as the PAN-ID hub security device and cardholding apparatus that implements security and communications. If the user's fingerprint authentication attempt is unsuccessful, then the LED 216 will light red and no functions will be enabled.

Also shown is pushbutton 212 which is used to enable optional pairing operations to take place between Bluetooth devices based upon high-security options of the Bluetooth standard. Not shown is the smartcard microprocessor and memory.

FIG. 3a shows the main components of the PAN security system. Apparatus 302a is equivalent to the PAN-ID security hub/cardholding apparatus of the invention. A Cell phone 304a is shown.

Cell Phone 304a can also contact cell tower 317a via telecommunications signals 316a in order to access the internet or other cellular-accessible resources, in accordance with security restrictions in the ID smartcard. Phone 304a also contains added software that increases security of the phone by restricting its use in accordance with data described within the ID smartcard and by encrypting the data in the phone and/or digitally signing digital data on the phone in transit that reside within the ID smartcard.

Headset 306a is shown which includes software to implement higher levels of Bluetooth security as indicated on the ID smartcard inserted in device 302a. Similarly, heads-up eyeglass display 308a may be optionally implemented for use with cell phone 304a or the network server whose security is defined in device 302a. Also, PC-PAD or PC-laptop computer 312a also contains software which enables its security to be controlled by PAN-ID security hub/cardholding device 302a. Optional WAN 314a shows an alternative or an additional connectivity resource (yet another communications option) to cellular device 304a. Doors, controllable barriers, and other physical-access mechanisms can be accessed by physical-access control boxes (not shown) mounted near a controllable door (not shown). The device 302a communicates via wireless link (e.g., Bluetooth or RFID) to identify employees and provide physical access as needed. Wireless links 320a, 322a, and 324a show connecting PAN hub security apparatus 302a to a cellphone 304a, a tablet computer 310a, or a laptop 312a, respectively.

FIG. 3b depicts a typical data structure within the ID smartcard as used by the PAN-ID security hub. Table 320 contains security parameters that cannot be changed without supervisor/security officer access privileges for each of the devices that can be connected in the hub. Security officers have access codes that unlock the files to enable smartcard enrollment and the entry of security data.

When a device is connected, the units identify themselves and the device address can be looked up in the table in column 324b.

That device address is looked up in 324b as an index for a row of security information pertaining to that device. As the connection is about to be made, the PAN-ID security hub determines the designated and approved security protocol which is to be used from column 326b, using protocol parameters at column 328b, then gets the number which represents the identities of the keys and certificates at column 330b. (Note, keys are not directly readable but cryptographic operations within a card require that they be identified so they can be used by the card's cryptographic software. Security parameters indicating the strength of cryptography that must be used and the other cryptographic parameters are available in column 328a, along with what types of models of equipment are authorized for use as being sufficiently secure, or if the equipment to be used is of the authorized type. This includes the communications parameters for such as Bluetooth to ensure that security is maintained.

One of the purposes of the table is to ensure that communications pairing is not used in a promiscuous manner, but only by devices that are authorized by the card issuer. For example, the cell phone 304a in FIG. 3a has its device address on row 304b of the table in FIG. 3b and that line contains an indication of the security protocol, key indices, and other security parameters for the cell phone. The other devices in FIG. 3a have corresponding row entries on FIG. 3b. For example, the Network Server 314a of FIG. 3a is found on row 314b on FIG. 3b and this row contains the authorized security parameters for WAN communications on the local network.

FIG. 4 shows a high-level summary of typical steps (of one preferred embodiment) of a secure wireless interconnection protocol employed to implement the secure PAN hub network platform apparatus of my invention. The FIG. 4 shows, e.g., the sequence of steps to establish secure communications between a Cellular Smartphone 402 and a Back-end Server 403. This protocol sequence represents but one possible device interconnection scenario illustrating the security process and a similar process could be used to establish secure communications between any set of devices that are members of the PAN network. For example, this system could establish secure communications between the Cellular Smartphone 402 and a Headset (not shown).

In the example of FIG. 4, the Pan User 400 initiates a phone call or message exchange with a secure server. When the call is initiated, a program in the Cellular Smartphone establishes a secure Connection 1 with the PAD Security Hub 401 for the purpose of establishing a keying relationship between the Cellular Smartphone 402 and the Back-end Server 403 In this example, a card reader slot in PAD Security Hub 401 has a smartcard inserted which contains private cryptographic keys and public key certificates that have been exclusively assigned to the PAN User.

The PAN Security Hub 401 then performs an authenticated version of the Diffie-Hellman key generation algorithm, known to the art as described in US Patent 4,200,770 to Hellman, Diffie, Merkle to generate secure cryptographic keys to encrypt the aforementioned session.

The program in the PAN Security Hub 401 also authenticates the messages using keys and certificates in the smartcard to ensure that the key exchange and messages are authenticated between the Smartphone 402 and the Back-end Server 403 and were exchanges with the intended party. The authentication mechanism itself is known to the art and is described in Internet Engineering Working Group Request for Comments: RFC4419, among others.

An additional step, Authentication 2, may be taken to ensure that the PAN User 400 is the authentic cardholding individual that is authorized to use the card to access and use the PAN system. The PAN User 400 may be required to enter a PIN or password on the screen of the Cellular Smartphone 403 in order to verify his or her identity. The PIN or password is verified by comparing it with an authorized copy stored in the smartcard that is inserted in the PAN Security Hub 401. Alternately the authentication security requirements established by the PAN security system may require that the PAN User 400 touch a fingerprint sensor on the PAN Security Hub 401 in order to provide a fingerprint that matches the fingerprint template on the smartcard that is inserted in the PAN Security Hub 401.

Biometric authentication techniques such as fingerprint matching are known to the art and are described in such documents as my U.S. Pat. No. 7,480,637 to Kozlay.

In order to improve security, a Challenge-Response 3 step may be performed. Security requirements may require that the PAN Security Hub 401 periodically challenge the Back-end Server 403 with a freshly generated random number and the Back-end Server 403 is expected to encrypt this number with an algorithm and key determined in the Connection 1 step, above. The encrypted response will be received by the PAN Security Hub, decrypted, and compared with the random number challenge originally sent.

If the random numbers sent and received in the Challenge-response 3 match, then the session is permitted to be established and encrypted and authenticated data will commence between the Cellular Smartphone 402 and the Back-end Server 403. The secured communication path is shown in FIG. 4 as the Secure Session 4.

Note that the secure communication session example illustrated in FIG. 4 may or may not be part of the security system built-in to most PAN networks, such as Bluetooth security. If Bluetooth security meets the requirements of the organization controlling PAN deployment, then the PAN Security Hub 401 coordinates the Security Establishment Sequence of FIG. 4 with an authenticating device such as the fingerprint authentication capability and also controls the encryption and digital signature services for data at rest (in the memory of PAN devices). However, PAN and associated network security requirements often exceed that which is provided by standard Bluetooth security protocol as described in the US Army's Wireless Security Standards V3.0 which may be found at: http://www.cwnp.com/pdf/BBP Wireless Security Standards VER 3 0.pdf

In such cases, the Secure Session 4 exchange of the example in FIG. 4 is implemented as a cryptographic tunnel within the Bluetooth data packets as described in the literature such as the Internet RFC2637 Point-to-Point Tunneling Protocol (PPTP).

The features of this invention improve upon the security protocols of Bluetooth by adding such a tunnel that uses government approved cryptographic algorithms and extended key lengths. The PAN Security System also provides for on-card encryption, on-card cryptographic authentication, on-card fingerprint template matching, and other enhanced security features described above.

Operation

Enrollment

PAN hub security apparatuses are optionally provisioned to be issued to users who are securely enrolled into their own assigned device. For example, a user can be issued and enrolled into their assigned PAN hub security apparatus (usually, by a network security administrator) by either (1) having authentication credentials provisioned into one or more of an ID smartcard (or other ID card), and/or (2) being issued and enrolled into a SIM card (such as typically used in cellphone enrollment), or (3) being assigned a Personal Identification Number (PIN) and/or a conventional password. This allows the organization and security administrators to positively document authorized users being issued and enrolled into their assigned PAN hub security apparatus.

SIM cards are well known in the art. They are small chip-cards that store data in non-volatile memory, and are typically used in cellular telephones, smartphones, etc. Alternates are either the ID smartcard authentication credential or the PIN/password.

Where the ID smartcard implementation option is deployed, the ID smartcards can be any memory cards capable of storing tables of data, such as: the PIV (Personal Identity Verification) card, the CAC (Common Access Card), the TWIC (Transportation Worker Identity Card), RFID proximity cards, or other standard smartcards used by organizations to protect their employees' identity and to hold information in their internal memories. When the users of such cards are enrolled, the user's identity is verified and identified by the organization, and identifying information such as user name, picture, and unique cryptographic keys and certificates are securely stored within the card's memory.

The more sophisticated versions of these cards also contain a cryptographic processor that is capable of performing encryption, as well as digital signature calculation based upon cryptographic keys stored within the card.

Additional information in the card may identify the types of PAN-attached peripherals that are authorized by the card-issuing organization, as well as the minimum security settings to be required for each peripheral to be used with the PAN. The structure of much of this data is already specified by existing standards, such as the PIV, CAC, and TWIC cards. For cards in which the data structure is not specified in public standards, a sample data structure is described in, FIG. 3b, later in this document.

Typical Usage

This section describes typical usage for the version of the PAN Security HUB which securely stores the security credentials in a smartcard, although usage is similar for versions that use a SIM card or internal nonvolatile memory to store the security credentials.

The “method” of the invention provides a series of steps wherein

(1) The management of an organization agrees to certain established and defined procedures and network rules for implementing robust security;

(2) Management selects PAN peripherals and connections permitted to be used within the organization and which may be granted access to organization networks;

(3) Management authorizes one or more departments of the organization to issue a smartcard to each PAN user identifying each such user, and determining each of those users' access privileges, and providing certificates and keys for use in cryptographically protecting data being communicated, and/or data at rest in device memory. These security credentials may also be used to allow designated employees to access other networkable devices external to their own PAN such as wide area networks or door locks that are installed with the ability to perform logical and/or physical access control.

(4) Each user is issued a PAN Security Hub to wear or carry on his or her person.

(5) The user inserts the card into the PAN Security Hub and ensures that the other PAN devices are paired with the PAN Security Hub and each other. This entails either entering a required code that is issued by one device into the other device of the secure pair, or else looking at or listening to each device to ensure that the codes match and, if they do, then take some action such as a button push to optionally enable the pairing to be consummated. Standard pairing procedures are described in the Bluetooth STIG standards document and do not have to be repeated here. The pairing procedure levels of security may be indicated in column 326 of the table of FIG. 3b, PAN Peripheral Security Profile Directory.(6) The user operates the PAN devices normally and the PAN Security Hub automatically provides the appropriate device access control and cryptography to provide secure PAN utilization.

I claim:

1. A Personal Area Network (PAN) Security System for (1) providing security services to protect data communicated between PAN-hub-attached peripheral devices and/or data residing within said devices, and for (2) providing cryptographic keys and certificates for protecting communications between at least two of said PAN-hub-attached peripheral devices and devices external thereto, as well as for protecting data-at-rest in device memory, comprising:
at least one user assigned a set of security credentials which are stored in at least one of a smartcard inserted into and readable by said PAN hub security apparatus, a cellphone SIM card, and an internal nonvolatile memory;
and
at least one means for authenticating a user to the PAN hub security apparatus comprising at least one of a PIN, a password, and a user biometric authentication input into biometric reader having biometric authentication software.

2. The PAN Security System of claim 1, wherein said PAN hub security hub apparatus ensures that each PAN network device meets or exceeds the minimum security requirements established by the network security administrator for acceptance by said PAN network and further comprises:
said PAN security hub apparatus further adapted to hold security requirements storage in memory in at least one of a smartcard, a cellphone SIM card, and internal nonvolatile memory;
said memory holding (1) at least one database of prospective attachable PAN peripheral devices, (2) minimum security requirements for attachment thereto, and (3) minimum-strength cryptographic variables, keys, and certificates required for attachment thereto;
said PAN peripheral devices to be enabled and interconnected with said PAN security hub apparatus but only after (1) a prospective user of said PAN Security System has self-authenticated with at least one of a PIN, a password, and a biometric and only after (2) security capabilities of said PAN peripheral devices were determined by said PAN hub security apparatus meet or exceed said minimum security requirements for use with said PAN network;
and
at least one security protocol for securely communicating and inter-exchanging data between said PAN security hub apparatus and said PAN peripheral devices.

3. The PAN system of claim 1, wherein said biometric authentication means further comprising at least one biometric authentication input from the group of fingerprints, voiceprints, handprints, hand geometry, facial characteristics, retina characteristics, iris characteristics, heartbeat characteristics, blood characteristics, and DNA characteristics.

4. The PAN system of claim 1, wherein said ID smartcard further includes at least one of chip-embedded data, inscribed indicia, embossed indicia, barcoded data, and other data and/or indicia applicable to the user.

5. The PAN system of claim 1, wherein said security credentials comprise at least one of device access privileges, data access privileges, device pairing data, public and/or private cryptographic key data, digital certificate data, biometric templates and reference data.

6. The PAN system of claim 1, wherein said PAN hub security apparatus including an ID cardholding device having an smartcard interface further comprises an insertion slot adapted to receive, display, and communicate ID smartcard data to and from said PAN hub security apparatus when said smartcard is inserted therewithin, and wherein said PAN hub security apparatus is further adapted to additionally communicate and inter-exchange said ID smartcard data with said at least one of said PAN hub-attached peripheral devices when said smartcard is inserted therewithin.

7. The PAN system of claim 1, wherein the security credentials and other parameters of said PAN hub security apparatus are updatable by insertion of a security administration ID card into said PAN security hub apparatus.

8. The PAN system of claim 1, wherein the security credentials and other parameters of said PAN hub security apparatus are updatable by means of cryptographically secured data downloaded from a security administration site on a network.

9. The PAN system of claim 1, wherein each of said peripheral devices attached to said PAN hub security apparatus is at least one of a wireless and a wire-attached device.

10. The PAN system of claim 1, wherein means for authenticating user-access to said PAN hub security apparatus additionally comprises means for authenticating subsequent user-access to at least one of said PAN-hub-attached peripheral devices via said PAN hub security apparatus.

11. The PAN system of claim 1, wherein said minimum PAN hub security requirements further require each user to biometrically authenticate themselves prior to accessing said PAN hub security apparatus and prior to subsequently accessing any of said PAN peripheral devices attached thereto.

12. The system of claim 2, wherein said minimum PAN hub security requirements further comprise at least one from the group of minimum biometric authentication capability, minimum cryptographic key length, minimum cryptographic key type, minimum digital certificate type and source, and minimum communications protocol security options.

13. A method for using a PAN hub security apparatus to provide security services to two or more peripheral devices connected to a PAN network and to external devices that are enabled to communicate with said PAN network, comprising the steps of:
issuing security credentials specific to a user and to an organization that are required to establish security services between devices attached to said PAN network;
storing said security credentials in a nonvolatile storage medium comprising at least one of a smartcard, a SIM card, and data securely downloaded to nonvolatile memory of said PAN hub security apparatus;
optionally enabling said PAN hub security apparatus by requiring a user to authenticate themself to said PAN hub security apparatus by at least one of a PIN, a password, and a biometric;
providing security credentials [including at least one of cryptographic keys, certificates, protocol security parameters, and pairing information] to secure data within and communications between two or more devices attached to said PAN network;
optionally determining by said PAN hub security apparatus the extent of at least one of physical and logical access privileges granted to said user based upon security credentials issued to said user;
and
commencing communications between and among said PAN-hub-attached devices connected to said PAN network and commencing communications with said external devices as permitted based upon said security credentials.

14. A PAN hub security apparatus including an enclosure, at least one processor having a memory containing a program adapted for (1) providing security services to protect data communicated between PAN-hub-attached peripheral devices and/or data residing within said devices, and for (2) providing cryptographic keys and certificates for protecting communications between at least two of said PAN-hub-attached peripheral devices and devices external thereto, as well as for protecting data-at-rest in device memory, comprising:
at least one user-assigned set of security credentials which are stored in at least one of a smartcard inserted into and readable by said PAN hub security apparatus, a cellphone SIM card, and an internal nonvolatile memory;
and
at least one means for authenticating a user to said PAN hub security apparatus comprising at least one of a PIN, a password, and a biometric reader with on-board authentication software.

15. The apparatus of claim 14, wherein said PAN hub security apparatus ensures that each PAN network device meets or exceeds the minimum security requirements established by the network security administrator for acceptance by and connection to said PAN network and further comprises:
said PAN security hub apparatus further adapted to hold security requirements stored in memory in at least one of a smartcard, a cellphone SIM card, and internal nonvolatile memory;
any of said memory devices holding (1) at least one database of prospective attachable PAN peripheral devices, (2) minimum security requirements for attachment thereto, and (3) stipulation of the minimum-strength cryptographic variables, keys, and certificates required for attachment thereto;
said PAN peripheral devices to be enabled and interconnected with said PAN security hub apparatus but optionally only after (1) security capabilities of said PAN peripheral devices were determined by said PAN hub security apparatus to meet or exceed said minimum security requirements for use with said PAN network, and optionally (2) a prospective user of said PAN Security System has self-authenticated with at least one of a PIN, a password, and a biometric;
and
at least one security protocol for securely communicating and inter-exchanging data between said PAN security hub apparatus and said PAN peripheral devices.

16. The apparatus of claim 14 wherein said biometric authentication means further comprising at least one biometric from the group of fingerprints, voiceprints, handprints, hand geometry, facial characteristics, retina characteristics, iris characteristics, heartbeat characteristics, blood characteristics, and DNA characteristics.

17. The apparatus of claim 14, wherein said ID smartcard further includes at least one of chip-embedded data comprising security credentials including at least one of device access privileges, data access privileges, device pairing data, public and/or private cryptographic key data, digital certificate data, biometric templates and reference data, and wherein the exterior surfaces of said ID smartcard optionally further includes at least one of inscribed indicia, user portrait, printed user name, embossed indicia, barcoded data, and other data and/or indicia applicable to the user.

18. The apparatus of claim 14, wherein the security credentials and other parameters of said PAN hub security apparatus are updatable by insertion of a security administration ID card into said PAN security hub apparatus.

19. The apparatus of claim 14, wherein each of said peripheral devices attached to said PAN hub security apparatus is at least one of a wireless and a wire-attached device.

20. The apparatus of claim 14, wherein the security credentials and other parameters of said PAN hub security apparatus are updatable by means of cryptographically secured data downloaded from a security administration site on a network.

21. A PAN hub security apparatus adapted for (1) ensuring, authorizing, and authenticating user access to said PAN hub security apparatus and for controlling subsequent user access to at least one of a PAN-network-attached device and optionally access to at least one device external thereto, for (2) ensuring PAN network-attached devices meet or exceed minimum security requirements for attachment to a PAN network, and for (3) communicating and inter-exchanging data elements between said PAN hub security apparatus and at least one PAN-network-attached device, comprising:
said PAN hub security apparatus further comprising a PAN network hub means for connecting PAN network security-requirement compliant devices thereinto, in order to form a secure network;
said PAN hub security apparatus additionally comprising an ID cardholding device with an ID-cardreading insertion slot and support means for presenting and displaying said ID card after a user has inserted their card therein;
at least one processor having a memory means for storing and executing software instructions and also having a cryptographic processor if required;
at least one database in memory and executing on said at least one processor; [including minimum interface requirements and minimum security standards]
communication means including at least one transceiver means for sending and receiving data between and among said PAN hub apparatus, PAN network hub-attached peripheral devices, and other devices external to said PAN network;
and
at least one power source.

22. The PAN hub security apparatus of claim 21, wherein means for authenticating user access thereto comprises at least one of biometric authentication means and non-biometric authentication means.

23. The PAN hub security apparatus of claim 21, wherein means for ensuring PAN-network-attachable devices meet or exceed PAN network device security requirements comprises means for communicating security profile data from said devices to said PAN hub security apparatus, and wherein said PAN hub security apparatus is further adapted to attach said devices to said PAN network, but only after said apparatus determines said devices meet or exceed required said PAN network device security requirements.

24. The PAN hub security apparatus of claim 21, wherein communicating data from said devices to said PAN hub security apparatus comprises at least one of (1) inter-exchanging pairing data between said PAN-hub apparatus and at least two network-attached device; (2) encrypting and decrypting inter-exchanged data; (3) digitally signing inter-exchanged data; means (4) cryptographically protecting data inter-exchanged between said devices by at least one of conventional and proprietary cryptographic protocol means; and/or (5) protecting data at rest in memory in at least one of said devices.

25. The PAN hub security apparatus of claim 21, wherein means for ensuring, authorizing, and authenticating user-access to a Personal Area Network hub security apparatus and PAN-hub-attached peripherals comprises biometric authentication means.

26. The PAN hub security apparatus of claim 21, wherein said biometric authentication means further comprising at least one biometric from the group of fingerprints, voiceprints, handprints, hand geometry, facial characteristics, retina characteristics, iris characteristics, heartbeat characteristics, blood characteristics, and DNA characteristics.

27. The PAN hub security apparatus of claim 21, wherein said ID smartcard includes at least one of inscribed indicia, embossed indicia, barcoded data, chip-embedded data, or other data and/or indicia indicative of said predetermined user privileges of said at least one user including cryptographic keys and certificates to protect communications to and from the device and data at rest within the memory of the device.

28. The PAN hub security apparatus of claim 21, wherein each said apparatus is assigned to at least one user and contains including cryptographic keys and certificates to protect communications to and from the user's device and data at rest within the users memory of the device.

29. The PAN hub security apparatus of claim 19, wherein said apparatus includes an ID cardholding device adapted for inserting, mounting, and displaying said ID card and wherein said ID cardholding device is further adapted for reading, interpreting, and transmitting said ID card indicia and embedded data comprising predetermined user privileges data to said processor including software instructions for processing said ID card indicia in said at least one PAN security hub apparatus.

30. The PAN hub security apparatus of claim 19, wherein said at least one processor further comprises at least one of a general purpose processor, a cryptographic processor, and an auxiliary processor for processing software instructions.

31. The PAN-hub security apparatus of claim 19, wherein said software instructions further include at least one of operating system software, application software, and authentication software further including means for processing cryptographic algorithms, encrypting and decrypting data, and/or other security software including Bluetooth pairing software.
